(19) United States
(12) Patent Application Publication
(10) Pub. No.: US 2002/0180753 A1
(43) Pub. Date: Dec. 5, 2002

(54) Color image space model establishment method and its data inquiry procedure

(76) Inventor: Lin Lin Chen, La Canada, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 09/871,632

(22) Filed: Jun. 4, 2001

(51) Int. Cl. G09G 5/02

(52) U.S. Cl. 345/591

(57) ABSTRACT

A method of establishing a color image space model including the steps of: (a) setting a standard color card containing a series of reference colors for use as a color data bank, and then setting a table of relative adjectives; (b) setting a color comment questionnaire subject to the standard color card and table of relative objectives thus obtained; (c) selecting at least one particular group people to make an investigation subject to the set color comment questionnaire, and then collecting and arranging the investigation result thus obtained so as to set up effective statistic data; and (d) using an analysis mode to compute the effective statistic data thus obtained, so as to establish a specific color image space model.

### BACKGROUND OF THE INVENTION

The present invention relates to a method of establishing a color image space model and, more particularly, to such a method of establishing a color image space model, which uses a scientific research method to establish a color image space model data bank for helping product designs to design products subject to the color feeling of particular consumers.

When designing consumer products, Internet home appliances, packed food products, garments, and etc., color is one of the important factors to attract consumers in addition to function and outer appearance. A particular color or bright color can immediately catch consumers' eyes, or attract consumers to buy the product. The color of a product represents its outer appearance, and can also effectively express the meanings of its design. For example, Chinese people regards red color as to represent wealth, satisfaction, or passion so that red color is commonly used in packing material or trademark; white color is commonly regarded as the representative of purity and noble and intensively used in wedding dresses. Every human race or people of a particular space may have a different feeling to a particular color.

The known color data establishment theories include Color Appearance Model, for example, CIELAB and CIEXYZ, which predicts color appearance under different observation conditions and different observation equipment, and Color Order System Model, for example, MUNSELL and OSTWALD, which uses a standard system to assign a particular color. The aforesaid two theories do not discuss consumers' color feelings. All the data of people's feeling about colors are obtained from oral rumor, but not through a scientific research. Further, people of different places or countries may have different feelings about same color. For example, yellow represents royal family and noble in China, however it means lust and open in the USA and European countries. Therefore, different colors should be used for products to be sold in different countries.

### SUMMARY OF THE INVENTION

The present invention has been accomplished under the circumstances in view. It is one object of the present invention to provide a method of establishing a color image space model, which uses a scientific research method to establish a color image space model data bank for enabling product designers to design products subject to the color feeling of particular consumers. It is another object of the present invention to provide a method of establishing a color image space model, which uses a scientific research method to establish a color image space model data bank for helping product designers select product color responsive to consumers feeling, so as to attract consumers to buy their products. It is still another object of the present invention to provide a method of establishing a color image space model, which uses a scientific research method to establish a color image space model data bank subject to people of different places, different races, different ages, different sexes, and different occupations. It is still another object of the present invention to provide a color image space model data bank inquiry procedure, which enables product designers to easily obtain the desired color for their products by means of an interactive or window picture inquiry method.

### BRIEF DESCRIPTION OF THE DRAWINGS

FIG. 1 is a flow chart showing a color image space model establishing procedure according to a first embodiment of the present invention.

FIG. 2 is a flow chart showing a color image space model establishing procedure according to a second embodiment of the present invention.

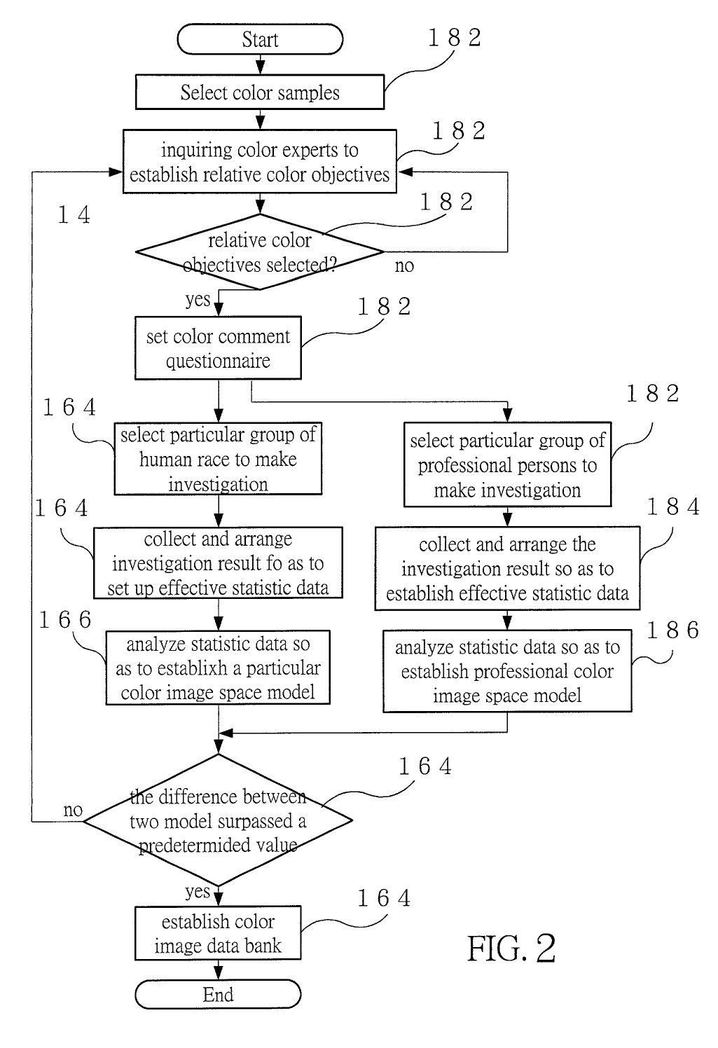

FIG. 3 illustrates a color image space model data bank inquiry procedure according to the present invention.

### DETAILED DESCRIPTION OF THE PREFERRED EMBODIMENT

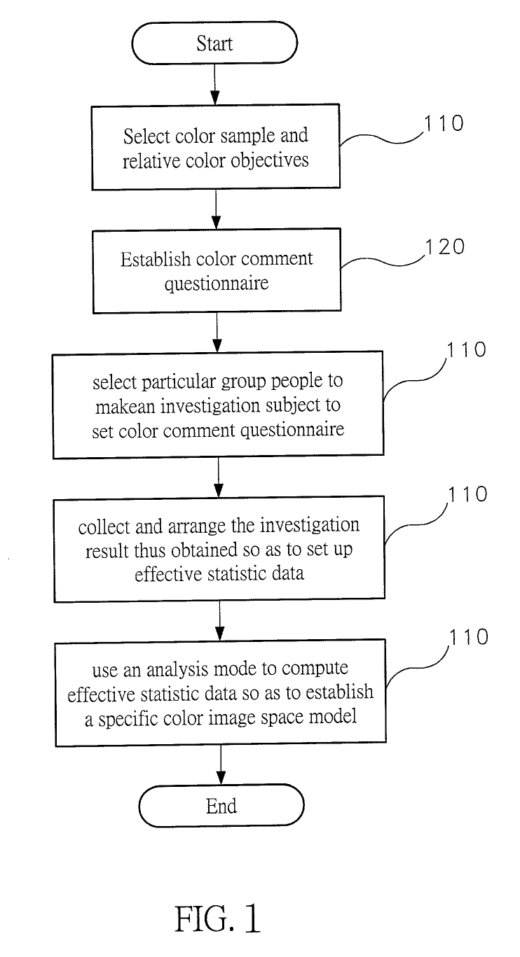

Referring to FIG. 1, a method of establishing a color image space model according to a first embodiment of the present invention comprises the steps of:

Step 110 selecting a standard color card containing a series of reference colors for use as a color data bank, for example, a standard color card containing base colors of white, red, yellow in red, yellow, green in yellow, green, purple in green, and black respectively provided in different brightness, darkness, and color tones, and then setting a table of relative adjectives, for example, bright-colored vs simple and plain, female vs male, natural vs artificial, honest vs deceitful, happy vs sad, international vs domestic, young vs mature, lovely vs disgusting, pessimistic vs optimistic, nice and cool vs deep and thick;

Step 120 setting a color comment questionnaire subject to the standard color card and table of relative objectives thus obtained, for example, attaching red color to a white paper and listing different adjectives arranged in grades (for example, five to seven grades);

Step 130 selecting a particular group of people to make an investigation subject to the set color comment questionnaire, for example, selecting a particular group of people from a particular place, sex, age, human race, physical type, occupation, or their combination; and then checking their instant reaction and feeling on every color listed in the color card by means of using the table of relative adjectives,

Step 140 collecting and arranging the investigation result thus obtained, so as to set up effective statistic data; and

Step 150 using multidimensional scaling, multidimensional preference, preference mapping, or their combination to analyze the statistic data thus obtained, so as to establish a color image space model.

After the establishment of the aforesaid color image space model, a product designer can than design products for particular people of particular places subject to the color image space model. However, because the relative adjectives are set in advance before investigation when establishing the aforesaid color image space model, investigation broadness is limited and, people's association of ideas is constrained. In order to eliminate these drawbacks, the following second embodiment may be employed.

The second embodiment of the method of establishing a color image space model comprises the steps of:

Step 210 selecting a color card containing a series of reference colors for use as a color data bank;

Step 211 inquiring color experts, for example, students of department of printing or industrial design of a particular area about their instant reaction and free feeling on every reference color of the color card by means of the use of free association of ideas as well as a pre-set table of relative objectives, and then listing available relative objectives indicative of every color listed in the color card by means of statistics;

Step 213 judging if to use or not to use every listed couple of relative objectives indicative of every color lifted in the color card, and then proceeding to Step 220 if positive, or to Step 211 if negative (in case the difference between the objectives of the free association of ideas and the objectives of the pre-set table of relative objectives for a particular color is significant, it means that the objectives of the pre-set table of relative objectives is biased not representative;

Step 220 setting a color comment questionnaire subject to the standard color card and table of relative objectives thus obtained;

Step 230 selecting a particular group of human race to make an investigation subject to the set color comment questionnaire,

Step 240 collecting and arranging the investigation result thus obtained from Step 230, so as to set up effective statistic data;

Step 250 using multidimensional scaling, multidimensional preference, preference mapping, or their combination to analyze the statistic data thus obtained, so as to establish a particular color image space model;

Step 235 selecting a particular group of professional persons to make an investigation subject to the set color comment questionnaire,

Step 245 collecting and arranging the investigation result thus obtained from Step 235, so as to set up effective statistic data;

Step 255 using multidimensional scaling, multidimensional preference, preference mapping, or their combination to analyze the statistic data thus obtained, so as to establish a professional color image space model;

Step 260 comparing and judging the difference between the particular color image space model obtained from Step 250 and the professional color image space model obtained from Step 255, and then returning to Step 211 if the difference surpassed a predetermined value, or proceeding to following Step 270;

Step 270 establishing a color image data bank subject to the particular color image space model obtained from Step 260 for use in an on-line, interactive, or window picture inquiry system by means of the application of a package software or Internet program language.

The aforesaid second embodiment of the present invention has considered the factors of different geometric areas, different groups of human races, people of different professions. When establishing a regular color image space model, Step 235, Step 245, Step 255 and Step 260 can be eliminated.

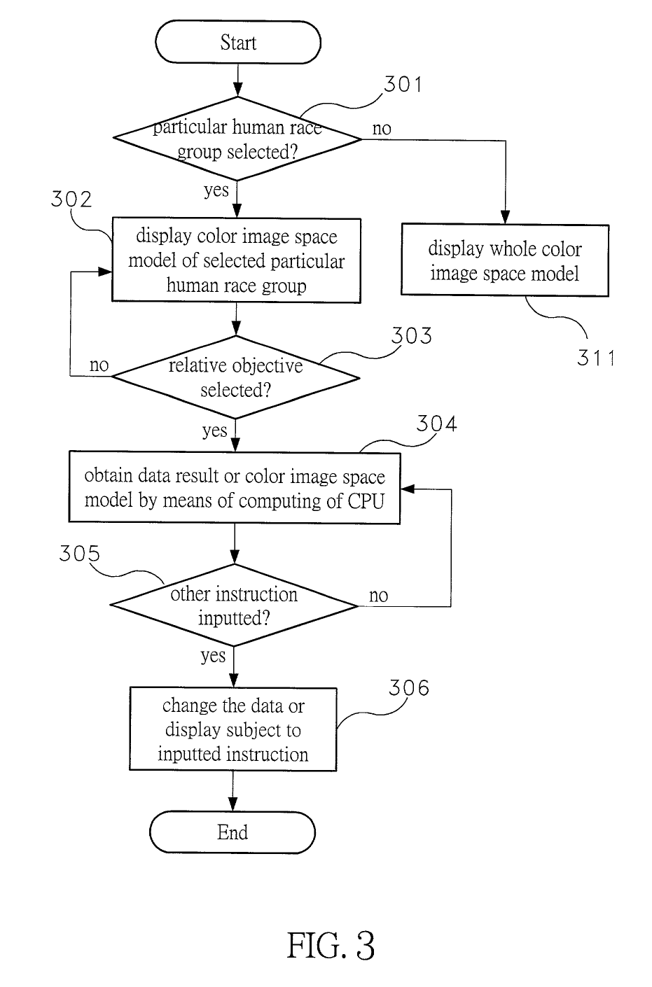

FIG. 3 illustrates a color image space model data bank inquiry procedure according to the present invention. This procedure includes the steps of:

Step 301 scanning the presence of an inputted particular human race group selection code, and then proceeding to Step 302 if positive, or proceeding to Step 311 to display the whole color image space model;

Step 302 displaying the color image space model of the selected particular human race group by means of the computing of a CPU (central processing unit);

Step 303 scanning the presence of an inputted relative objective key word relating color selection, and then proceeding to Step 304 if positive, or returning to Step 302 if negative;

Step 304 obtaining the data result or color image space model for all colors regarding to the inputted particular human race and the relative objective;

Step 305 scanning the presence of any instruction inputted, for example, color sample color display, digital data conversion, color sample minimum value adjustment, color sample maximum value adjustment, background color selection, relative adjective display, change of human race, and etc., and then proceeding to Step 306 if positive, or returning to Step 304 if negative; and

Step 306 changing the data or display subject to the inputted instruction.

Although particular embodiments of the invention have been described in detail for purposes of illustration, various modifications and enhancements may be made without departing from the spirit and scope of the invention (for example, the plug rod can be made having a circular cross-section). Accordingly, the invention is not to be limited except as by the appended claims.

What the invention claimed is:

1. A method of establishing a color image space model comprising the steps of:
(a) setting a standard color card containing a series of reference colors for use as a color data bank, and then setting a table of relative adjectives;
(b) setting a color comment questionnaire subject to the standard color card and table of relative objectives thus obtained;
(c) selecting at least one particular group people to make an investigation subject to the set color comment questionnaire, and then collecting and arranging the investigation result thus obtained so as to set up effective statistic data; and
(d) using an analysis mode to compute the effective statistic data thus obtained, so as to establish a specific color image space model.

2. The method of establishing a color image space model of claim 1 wherein the setting of said table of relative adjectives is obtained by means of an inquiry research made on at least one group of color experts.

3. The method of establishing a color image space model of claim 2 further comprising the step of establishing a professional color image space model subject to said inquiry research on said at least one group of color experts.

4. The method of establishing a color image space model of claim 3 further comprising the step of comparing said specific color image space model and said professional color image space model.

5. The method of establishing a color image space model of claim 1 wherein said analysis mode is selected from one of multidimensional scaling, multidimensional preference, preference mapping, and their combination.

6. The method of establishing a color image space model of claim 1 wherein said at lest one particular group people is selected subject to one of the factors of sex, human race, age, place, physical type, occupation, and their combination.

7. The method of establishing a color image space model of claim 1 further comprising the step of establishing a color data bank subject to said effective statistic data and said specific color image space model.

8. A color image space model data bank inquiry procedure to use used in claim 7, comprising the steps of:
(a) selecting the code for at least one particular group of families;
(b) inputting at least one color adjective key word; and
(c) obtaining the related color image space model of the selected particular group of families by means of the computing of a central processing unit.

9. The color image space model data bank inquiry procedure of claim 8 further comprising the step of adjusting the color image space model subject to inputted instructions.
